(19) United States
(12) Patent Application Publication
(10) Pub. No.: US 2009/0188428 A1
(43) Pub. Date: Jul. 30, 2009

(54) SUBSTRATE PROCESSING APPARATUS

(75) Inventors: Isamu SAKURAGI, Nirasaki City (JP); Shigeru Tahara, Nirasaki City (JP); Kumiko Yamazaki, Nirasaki City (JP); Ryo Nonaka, Nirasaki City (JP); Morihiro Takanashi, Nirasaki City (JP); Eiichi Nishimura, Nirasaki City (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/361,004

(22) Filed: Jan. 28, 2009

Related U.S. Application Data
(60) Provisional application No. 61/048,341, filed on Apr. 28, 2008.

(30) Foreign Application Priority Data
Jan. 28, 2008 (JP) 2008-016661

(51) Int. Cl. B05C 13/00; B01J 19/00

(52) U.S. Cl. 118/56; 118/64; 422/198

(57) ABSTRACT

A substrate processing apparatus includes a processing vessel; a mounting table for mounting the substrate thereon in the processing vessel; a gas inlet unit provided in the processing vessel; a gas supply mechanism for supplying a hydrogen-containing gas into the processing vessel through the gas inlet unit; a gas discharge port provided at the processing vessel; a gas exhaust mechanism for exhausting an inside of the processing vessel through the gas discharge port; a catalyst provided in the processing vessel; and a heating unit for heating the catalyst. Hydrogen radicals are formed in the processing vessel by a catalytic cracking reaction between the hydrogen-containing gas and the catalyst of high temperature, and the substrate is processed by the hydrogen radicals.

### FIELD OF THE INVENTION

The present invention relates to a substrate processing apparatus for peeling off a remaining resist on a substrate by a hydrogen gas that is produced by bringing a hydrogen-containing gas into contact with a high temperature catalyst.

### BACKGROUND OF THE INVENTION

In a manufacturing process of semiconductor devices, a photoresist pattern is formed by performing photolithography on a semiconductor wafer as a target substrate to be processed. The formed photoresist pattern is then used as a mask for etching and is peeled off after etching.

As for the photoresist peeling process, a dry ashing technique using a plasma and a wet ashing technique are the mainstream. Particularly, the dry ashing technique and the wet ashing technique are used in combination to peel resists that are deteriorated after performing ion implantation. However, the combined dry ashing and wet ashing approach makes the manufacturing process more complicated and takes more time. In addition, when the deteriorated resists are peeled off, undesirable residues can be remained on an underlayer of the resists, which require an additional process to clean them.

In order to solve such problems, Patent Document 1 discloses a method, in which atomic hydrogen (hydrogen radicals) is generated in a catalytic cracking reaction between peeling gas containing molecules having hydrogen atoms and a catalyst substance having high melting point such as heated tungsten (W) at high temperature, and the generated atomic hydrogen and the resist are brought into contact with each other whereby the resist is gasified to be peeled off. As a result, a resist can be peeled off through this simplified process and an underlayer surface thereof can be cleaned after peeling off the resist.

However, it has been found that repetition of the resist exfoliation method described in Patent Document 1 can deteriorate the catalyst substance, which leads to deterioration in catalyst performance, shortened life, and generation of particles.

Further, in Patent Document 1, a tungsten wire used as the catalyst substance is mounted on a target substrate having thereon resist, and hydrogen radicals produced by catalytic contact are applied to the resist on the substrate directly thereunder to perform the resist peeling process. However, it is still needed to speed up the resist peeling process by increasing an amount of the hydrogen radicals.

[Patent Document 1] Japanese Patent Laid-open Application No. 2002-289586

### SUMMARY OF THE INVENTION

The present invention provides a substrate processing apparatus for processing a substrate with hydrogen radicals that are produced by the catalytic cracking reaction between a hydrogen-containing gas and a high temperature catalyst, and preventing the catalyst from being deteriorated due to by-products generated from the processing.

The present invention further provides a substrate processing apparatus capable of increasing the amount of hydrogen radicals.

In accordance with a first aspect of the present invention, there is provided a substrate processing apparatus, including a processing vessel for accommodating a substrate therein; a mounting table for mounting the substrate thereon in the processing vessel; a gas inlet unit provided in the processing vessel; a gas supply mechanism for supplying a hydrogen-containing gas into the processing vessel through the gas inlet unit; a gas discharge port provided at the processing vessel; a gas exhaust mechanism for exhausting an inside of the processing vessel through the gas discharge port; a catalyst provided in the processing vessel; and a heating unit for heating the catalyst.

In the processing apparatus, hydrogen radicals are formed in the processing vessel by a catalytic cracking reaction between the hydrogen-containing gas and the catalyst of high temperature, and the substrate is processed by the formed hydrogen radicals, and the apparatus further comprises a baffle plate partitioning a space where the catalyst is present from a processing space for processing the substrate by using the hydrogen radicals.

In accordance with the first aspect, it is preferable to provide, in the apparatus, an exhausting baffle plate partitioning the space for processing the substrate by the hydrogen radicals from a gas exhaust space including the gas discharge port. Further, the process may generate a carbon-containing material, and in this case, the baffle plate preferably has holes, each hole having a diameter allowing the hydrogen radicals to pass therethrough but suppressing the carbon-containing material from passing therethrough.

Further, when the process generates a carbon-containing material, the catalyst may have a carbon compound layer pre-coated on a surface thereof. In this case, the carbon compound layer may be formed on the surface of the catalyst by performing a hydrogen radical process on the carbon-containing matter within the processing vessel.

Further, the gas inlet unit preferably has a shower head facing the mounting table for discharging a hydrogen-containing gas in a shower shape toward an entire surface of a substrate as the target to be mounted, and the catalyst is provided directly underneath the shower head.

In accordance with a second aspect of the present invention, there is provided a substrate processing apparatus, including: a processing vessel for accommodating a substrate therein; a mounting table for mounting the substrate thereon in the processing vessel; a gas inlet unit provided in the processing vessel; a gas supply mechanism for supplying a hydrogen-containing gas into the processing vessel through the gas inlet unit; a gas discharge port provided at the processing vessel; a gas exhaust mechanism for exhausting an inside of the processing vessel through the gas discharge port; a catalyst provided in the processing vessel; and a heating unit for heating the catalyst.

In the substrate processing apparatus, hydrogen radicals are formed in the processing vessel by a catalytic cracking reaction between the hydrogen-containing gas and the catalyst of high temperature, and a process is performed onto the substrate by the formed hydrogen radicals, and the catalyst is provided in a manner that the hydrogen-containing gas introduced from the gas inlet unit is brought into contact with the catalyst before the hydrogen-containing gas is diffused into the processing vessel.

In accordance with the second aspect, the gas inlet unit may include an inlet port for introducing a hydrogen-containing gas into the processing vessel, a guide member for guiding the hydrogen-containing gas introduced from the inlet port toward an outer periphery of an upper portion of the processing vessel, and a discharge port for discharging the hydrogen-containing gas guided by the guide member toward the outer periphery of the processing vessel in a circular shape, the catalyst being provided directly underneath the discharge port.

Further, the gas inlet unit preferably includes an inlet port for introducing a hydrogen-containing gas into the processing vessel, a guide member for guiding the hydrogen-containing gas introduced from the inlet port toward an outer periphery of an upper portion of the processing vessel, and a discharge port for discharging the hydrogen-containing gas guided by the guide member toward the outer periphery of the processing vessel in a circular shape, the catalyst being provided in a space between the inlet port and the guide member.

In accordance with the first and the second aspect, the apparatus may peel off a resist formed on the substrate. Further, the apparatus preferably removes a backside polymer adhered to a rear surface of the substrate. Further, an arrangement pattern of the catalyst is preferably adjusted to regulate a processing rate. Preferably, the catalyst has a wire shape, and is formed of tungsten.

In accordance with the present invention, the processing vessel is provided with a baffle plate so that a chamber where the catalyst is present is partitioned from a chamber used for substrate processing by hydrogen radicals. In this way, products from the substrate process are prevented from approaching the catalyst and the catalyst is protected against degradation. Especially, when the substrate processing involves a resist ashing process, carbon-containing materials separated from the resist the catalyst and carbonize the surface of the resist. This resultantly degrades catalyst performance, or shorten life by forming brittle carbon compounds which produces particles when peeled off. However, the presence of the baffle plate can suppress such an unintended unfavorable result.

In addition, in accordance with the present invention, the catalyst is positioned to make a contact with a hydrogen-containing gas discharged from a gas inlet port before it is diffused within the processing vessel. Thus, high concentration hydrogen-containing gas prior to diffusion is brought into contact with the catalyst, and the hydrogen radical production efficiency can be improved, thereby improving the overall processing speed.

### BRIEF DESCRIPTION OF THE DRAWINGS

The objects and features of the present invention will become apparent from the following description of preferred embodiments, given in conjunction with the accompanying drawings, in which:

FIG. 1 is a schematic cross-sectional view showing a substrate processing apparatus in accordance with a first embodiment of the present invention;

FIG. 2 is a view showing an arrangement pattern of a catalyst wire in the substrate processing apparatus in accordance with the first embodiment of the present invention;

FIG. 3 shows a relationship between temperature of the catalyst wire and an ashing rate (peeling rate);

FIG. 4 shows a relationship between a pressure in the chamber and the ashing rate (peeling rate);

FIG. 5 shows a relationship between wafer temperature and the ashing rate (peeling rate);

FIG. 6 shows a relationship between a H₂ gas flow rate and the ashing rate (peeling rate);

FIG. 7 shows an example of a modification of configuration density of the catalyst wire;

FIGS. 8A and 8B show secondary ion mass spectrometry (SIMS) results of a tungsten catalyst wire in depth direction after the resist peeling treatment on the first lot and the sixth lot;

FIG. 9 shows a relationship between count number of treated wafer sheets and ashing rate, and a variation in ashing rate in relationship to count number of treated wafer sheets;

FIG. 10 is a pattern diagram for explaining the backside polymer removal with hydrogen radicals;

FIG. 11 is a cross-sectional view showing a substrate processing apparatus in accordance with a second embodiment of the present invention;

FIG. 12 is a view showing an arrangement pattern of a catalyst wire in the substrate processing apparatus in accordance with the second embodiment of the present invention; and

FIG. 13 shows another example of the arrangement pattern of catalyst wire in the substrate processing apparatus in accordance with the second embodiment of the present invention.

### DETAILED DESCRIPTION OF THE EMBODIMENTS

Hereinafter, the embodiments of the present invention will be described in detail with accompanying drawings which form a part hereof.

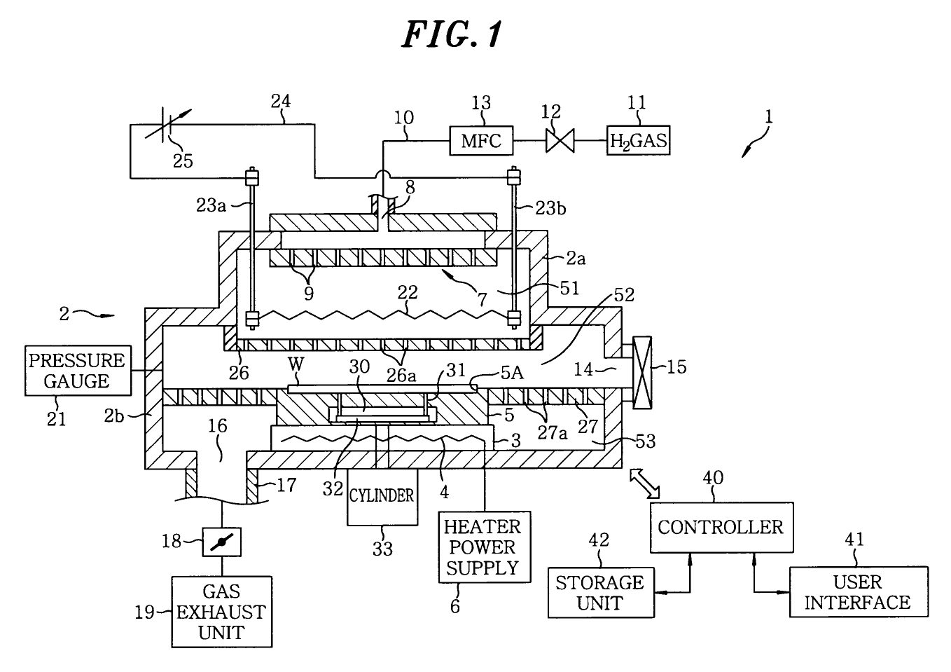

First, a first embodiment of the present invention will be described. FIG. 1 is a cross-sectional view showing a substrate processing apparatus in accordance with the first embodiment of the present invention.

A substrate processing apparatus 1 is configured as a resist peeling (ashing) apparatus, and has an evacuative chamber (processing vessel) 2. The chamber 2 includes an upper portion 2a of a small diameter and a lower portion 2b of a large diameter. Placed on the bottom of the lower portion 2b is a heater plate 3 having a heater 4 buried therein, and a wafer stage 5 to mount thereon a semiconductor wafer (hereinafter, simply referred to as a wafer) W is placed on the heater plate 3, the wafer being served as a target substrate to be processed having a resist film to be peeled off. A recess 5a for mounting the wafer W thereon is formed on the top surface of the wafer stage 5. The heater 4 is electrically fed from a heater power supply 6.

The wafer stage 5 has a space 30 therein, and three wafer lift pins 31 (only two of them are shown) are provided to vertically move through the space 30, while being supported onto a support plate 32. The wafer lift pins 31 move vertically by a cylinder 33 that is disposed under the chamber 2 via the support plate 32 to be moved upward or downward from/to the top surface of the wafer stage 5, whereby the wafer W can vertically move with respect to the wafer stage 5.

The upper portion 2a of the chamber 2 has a hollow disk-shaped shower head 7 facing the wafer stage 5 to supply a peeling gas, H₂ gas, into the chamber 2. The shower head 7 has a gas inlet port 8 at the center of the top surface thereof, and gas discharge holes 9 at the bottom surface thereof.

The gas inlet port 8 is connected to one end of a gas supply line 10, and the other end of the gas supply line 10 is connected to a H₂ gas supply source 11 for supplying H₂ gas as the peeling gas. Moreover, an opening/closing valve 12 and a mass flow controller (MFC) 13 functioning as a flow controller are installed in the gas supply line 10. The peeling gas is not limited to H₂ gas, but may be, for example, SiH₄, CH₄, NH₃ or the like, as long as they contain hydrogen and generate hydrogen radicals (atomic hydrogen) by making a contact with a high temperature catalyst wire 22 (to be described later).

A loading/unloading port 14 for loading/unloading the wafer W is formed at a sidewall of the chamber 2, and the loading/unloading port 14 is opened or closed by a gate valve 15. In addition, a gas exhaust port 16 is formed in the bottom of the chamber 2 and is connected to a gas exhaust line 17. Also, an automatic pressure controller (APC) 18 and a gas exhaust unit having a vacuum pump such as a turbo molecular pump are connected to the gas exhaust line 17. The inner pressure of the chamber 2 is detected by a pressure gauge 21, so that an opening degree of the APC 18 can be controlled.

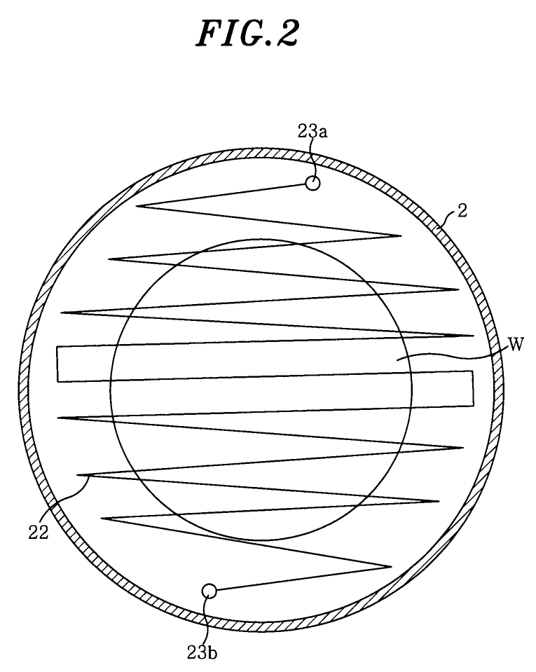

At the lower portion of the upper portion 2a of the chamber 2, a catalyst wire 22 made of a conductive high melting point material, e.g., tungsten, is positioned between the wafer stage 5 and the shower head 7. As shown in FIG. 2, the catalyst wire 22 is stretched to cover the entire cross section of the upper portion 2a. Both ends of the catalyst wire 22 are connected to electrodes 23a and 23b, respectively and the electrodes 23a and 23b are upwardly extended to thereby be extended from the chamber 2. A power supply line 24 is connected between the electrodes 23a and 23b, and a variable DC power supply 25 is connected to the power supply line 24 to feed a power to the catalyst wire 22. By feeding the electrical power to the catalyst wire 22 from the variable DC power supply 25, the catalyst wire 22 is heated to a high temperature above 1400° C. for example. Then, H₂ gas is brought into contact with the heated catalyst wire 22 to generate hydrogen radicals. The material of the catalyst wire 22 is not limited to tungsten, but may be other high melting point metallic catalysts such as Pt, Ta, Mo or the like.

Provided directly underneath the catalyst wire 22 is a baffle plate 26 to cover a bottom surface of the upper portion 2a. To be more specific, the baffle plate 26 partitions a hydrogen radical forming space 51 for forming hydrogen radicals by the catalyst wire 22 from a processing space 52 for processing the wafer W with the hydrogen radicals. The baffle plate 26 has holes 26a. By the baffle plate 26, conductance is regulated so that a pressure in the processing space 52 becomes relatively lower than that in the hydrogen radical forming space 51, thereby developing a pressure difference between the spaces. As a result, even though hydrogen radicals generated by the catalyst wire 22 can easily be diffused toward the processing space 52 for processing wafer W, separated matters decomposed from the resist during a processing by the hydrogen radicals are prevented from being readily diffused into the hydrogen radical forming space 51.

An exhausting baffle plate 27 is installed between the upper side portion of the wafer stage 5 and the inner wall of the chamber 2. The exhausting baffle plate 27 is configured to partition the processing space 52 from an exhaust space 53 provided thereunder. The exhausting baffle plate 27 has holes 27a. With the presence of the exhausting baffle plate 27, conductance is regulated, so that the pressure in the exhaust space 53 can be relatively lower than that in the processing space 52, and the inside of the processing space 52 can be exhausted rapidly. Meanwhile, with the presence of the exhausting baffle plate 27, separated matters decomposed from the resist are prevented from being readily diffused into the exhaust space 53.

Each of the components of the substrate processing apparatus 1, such as, the peeling gas (i.e., H₂) supply units (e.g. the valve 12, the mass flow controller 13 and the like), the heater power supply 6, the APC 18 and the like is connected to and controlled by a controller (the entire control device) 40 which is a microprocessor (computer). The controller 40 is connected to a user interface 41 including a keyboard through which an operator inputs commands to manage the substrate processing apparatus 1, and a display for displaying an operation status of the substrate processing apparatus 1.

Further, the controller 40 is connected to a storage unit 42 which stores control programs to be used in realizing various processes performed in the substrate processing apparatus 1 and a program, i.e., a recipe, to execute a process in each component of the substrate processing apparatus 1 in accordance with processing conditions. The recipe is stored in a storage medium in the storage unit 42. The storage medium may be a hard disk, a semiconductor memory, or a portable (transferable) memory such as a CDROM, a DVD, a flash memory, or the like. Moreover, the recipe may be also transmitted from other apparatus via, e.g., a dedicated line.

Further, if necessary, a specific recipe may be called out from the storage unit 42 in response to instructions from the user interface 41 to have it to be executed by the controller 40, so that a desired processing can be carried out in the substrate processing apparatus 1 under the control of the controller 40.

A resist peeling process performed by the substrate processing apparatus 1 having the above-described configuration will be described.

After a target etching film of a wafer W to be processed is etched, a BARC (Bottom Anti-Reflection Coating) film and a resist film, which remain on the target etching film, are peeled off (ashed) by the substrate processing apparatus 1.

First, the gate valve 15 is opened, the above-described wafer W is loaded into the chamber 2 through the loading/unloading port 14 from a transfer chamber (not shown) that is maintained in a vacuum, and the wafer W is mounted on the wafer stage 5. In this state, the gas exhaust unit 19 is operated so that the inside of the chamber 2 is controlled to be maintained at a predetermined pressure (vacuum level) by the APC 18 based on a pressure value detected by the pressure gauge 21, while the heater 4 is heated by the heater power supply 6 to thereby heat the wafer W on the wafer stage 5 to a specific temperature.

Meanwhile, the catalyst wire 22 is electrically fed from the variable DC power supply 25 and is heated to a predetermined high temperature. The temperature of the catalyst wire 22 at this time is measured by a radiation pyrometer (not shown).

In the state in which the catalyst wire 22 is heated to a high temperature, the H₂ gas supply source 11 supplies H₂ gas into the chamber 2 through the gas supply line 10 and the shower head 7. A flow rate of the H₂ gas at this time is properly set depending on the type or quantity of a resist to be peeled off. The H₂ gas may also be diluted with an inert gas such as a rare gas or the like. As the inert gas, He gas, Ar gas, and the like may be used.

Then, when the H₂ gas is brought into contact with the heated catalyst wire 22, it becomes excited by the catalytic cracking reaction therebetween, so that hydrogen radicals (atomic hydrogen) are generated. The generated hydrogen radicals are then brought into contact with the resist film to decompose and remove the resist film by gasifying it, whereby the resist film can be peeled off. At this time, if the wafer W has been preheated to a specific temperature, the resist peeling reaction can be made more rapidly. Further, since the BARC has similar components as those of the resist, it can be decomposed and removed as well.

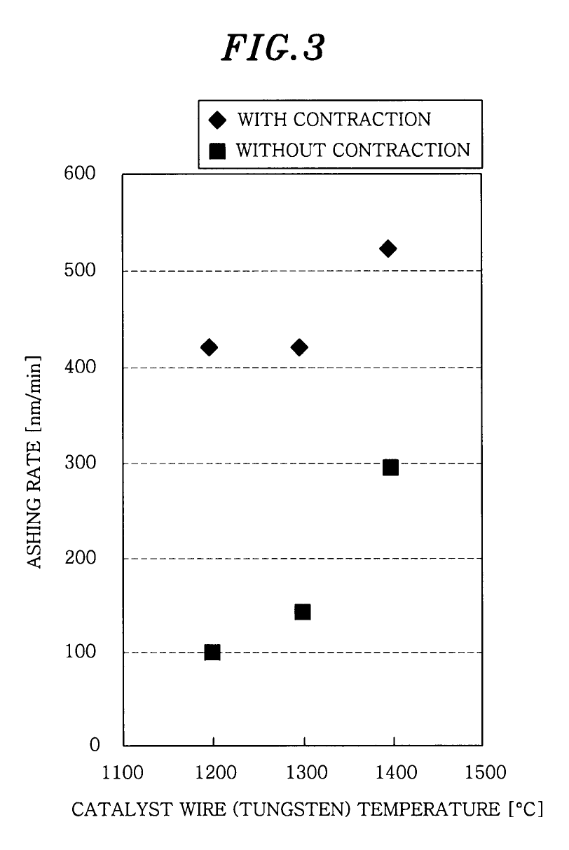

At this time, the catalyst wire 22 is preferably heated to 1400° C. or higher, which will be described below referring to FIG. 3. FIG. 3 shows a relationship between a temperature of the catalyst wire and an ashing rate (peeling rate), when an ashing process (peeling process) is carried out for 60 sec while varying the temperature of the tungsten catalyst wire in a range from 1200 to 1400° C., under the conditions where an inner chamber pressure is 500 mTorr (66.4 Pa); H₂ gas flow rate, 1000 sccm (mL/min); and wafer temperature, 250 to 275° C.

Further, FIG. 3 also shows a comparison between a case where a resist contraction due to the heated wafer W is included in the ashed resist thickness and a case where the resist contraction is not included in the ashed resist thickness (in the latter case, contraction ratio of the resist is measured for each condition, and the thickness difference considering the contraction was calculated). As illustrated in FIG. 3, the ashing rate is not saturated at 1400° C. and it increases as the temperature increases. Accordingly, the catalyst wire can be preferably heated to 1400° C. or above. It is not necessary to make a specific upper limit on the heating temperature, but the catalyst wire 22 can be cut off when heated to an excessively high temperature. Therefore, it is preferable to heat the catalyst wire in a temperate range from 1400 to 2000° C.

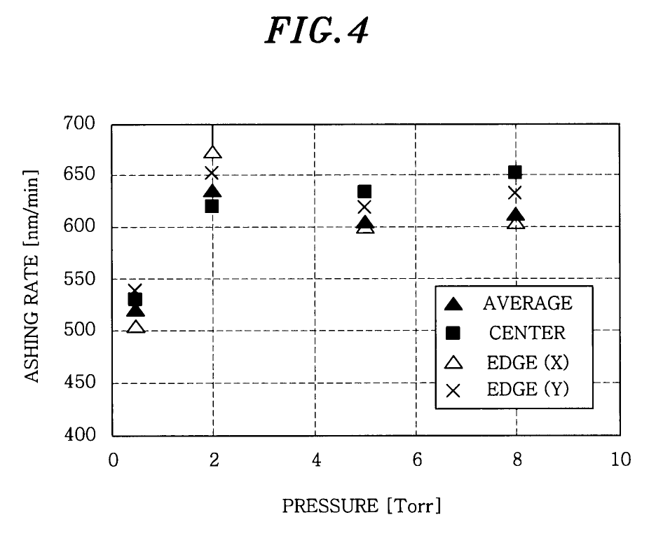

Further, the inner pressure of the chamber 2 in the resist peeling process is preferably in a range from 133 to 1333 Pa (1 to 10 Torr), which will be described below referring to FIG. 4. FIG. 4 shows a relationship between the inner chamber pressure and the ashing rate (peeling rate), when the ashing process (peeling processing) is carried out for 60 sec while varying in the pressure in the chamber 2 in a range from 500 mTorr to 8 Torr, under the conditions where H₂ gas flow rate is 1000 sccm (mL/min); wafer temperature, 250 to 275° C.; and tungsten catalyst wire temperature, 140° C.

As illustrated in FIG. 4, the ashing rate is still low at 500 mTorr (66.5 Pa), but it sharply rises beyond that and it becomes stable at 2 Torr (266 Pa) or higher. In general, when the pressure is above 1333 Pa (10 Torr), there is a possibility that a vast amount of gas needs be introduced to maintain a high pressure, depending on the pressure regulation scheme. Therefore, the pressure for the peeling process (ashing) using hydrogen radicals is preferably in a range from 133 to 1333 Pa (1 to 10 Torr).

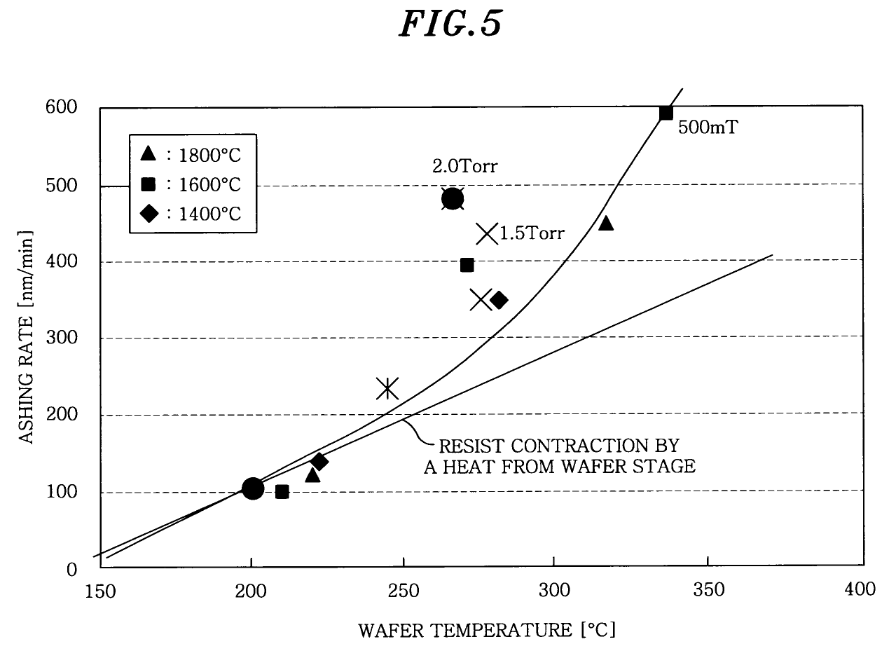

The wafer temperature for the resist peeling process is preferably in a range from 230 to 300° C., which will be described below referring to FIG. 5. FIG. 5 shows a relationship between a wafer temperature and the ashing rate (peeling rate) in a case where the inner chamber pressure or the temperature of the tungsten catalyst wire is varied and the wafer temperature is varied in a range from 200 to 330° C. with the H₂ gas flow rate of 1000 sccm (mL/min). As illustrated in FIG. 5, when the wafer temperature increases above 230° C., the ashing rate becomes higher than the resist contraction line, the resist contraction being caused by a heat from the wafer stage 5, and it is conceived the resist peeling is initiated. When the wafer temperature increases above 300° C., the film is likely to be degraded, when a low dielectric constant film (Low-k film) is used as an interlayer insulating film. Accordingly, the wafer temperature is preferably in a range from 230 to 300° C.

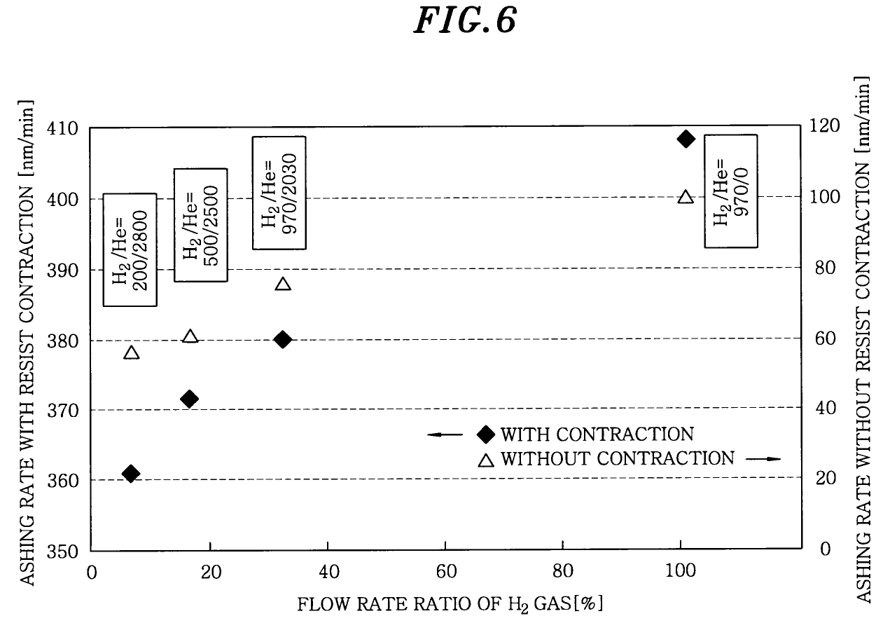

When H₂ gas is used as the peeling gas, as described above, it can be diluted with an inert gas. In this case, concentration of the H₂ gas (H₂ gas flow rate ratio) is preferably 5% or above. This will now be described referring to FIG. 6. FIG. 6 shows a relationship between a flow rate ratio of H₂ gas and the ashing rate (peeling rate), when He gas is used as a diluted gas of the H₂ gas.

FIG. 6, similarly to FIG. 3, shows a comparison between a case where the resist contraction due to the heated wafer W is included and a case where the resist contraction is not included. As described in FIG. 6, even though the ashing rate decreases as dilution of the H₂ gas into He gas increases, a sufficiently high ashing rate can be obtained when the concentration of the H₂ gas is 5% or higher. Therefore, the concentration of the H₂ gas is preferably 5% or higher. The wafer temperature is measured by a temperature sensor (not shown) such as a thermocouple which is buried in the wafer stage 5 to bring its front end into contact with the wafer W.

The ashing rate (peeling rate) also depends on an arrangement pattern of the catalyst wire 22. For instance, if the arrangement pattern of the catalyst wire 22 is increased, the ashing rate can also be increased. That is, the possibility of contact between the supplied H₂ gas and the catalyst wire 22 becomes higher as the arrangement pattern of the catalyst wire 22 increases. Accordingly, the amount of generated hydrogen radicals increases so that the ashing rate can be increased.

In such a case, if the catalyst wire 22 is positioned below the shower head 7 and H₂ gas is uniformly supplied in a form of downflow from the shower head 7 toward the wafer W, as in the present embodiment, the ashing rate uniformity can be controlled by regulating the arrangement pattern variation of the catalyst wire 22 because the ashing rate reflects the arrangement pattern variation of the catalyst wire 22. For example, by increasing the density of a catalyst wire portion corresponding to a region having a small ashing rate, the ashing rate uniformity can be improved while increasing the ashing rate. Further, it is also possible to regulate the arrangement pattern variation of the catalyst wire 22 to obtain a desired ashing rate.

An example of regulating the ashing rate by changing the arrangement pattern variation of the catalyst wire 22 is described bellow. Herein, first, a tungsten catalyst wire was prepared as illustrated in FIG. 2, and an ashing process (peeling process) was performed for 60 sec under the conditions where the inner chamber pressure is 500 mTorr (66.4 Pa); H₂ gas flow rate, 600 to 1000 sccm (mL/min); wafer temperature, 250° C.; and catalyst wire temperature, 1400° C.

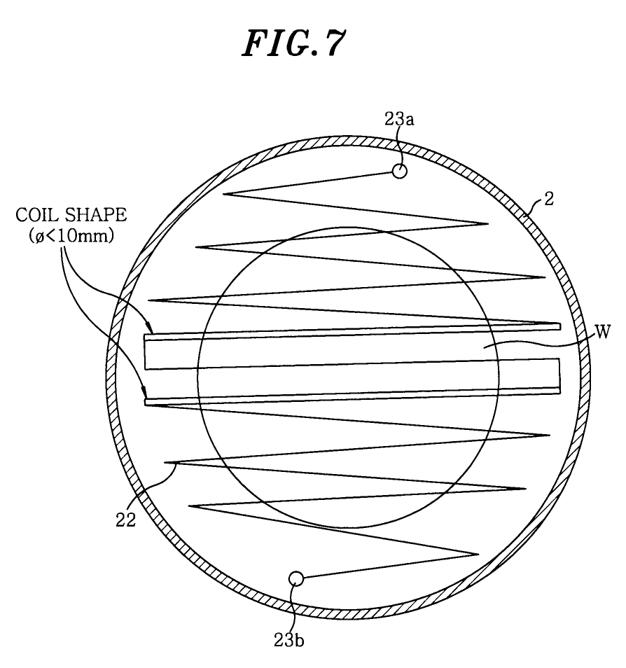

It turned out that the average ashing rate was 349.3 nm/min, and the ashing rate difference increased up to 13.4% because of the lower ashing rate at the central portion of the wafer. In this regard, as illustrated in FIG. 7, two spots at the central portion of the wafer W were adopted with a catalyst wire having a coil shape smaller than φ 10 mm. With this, the ashing rate at the center of the wafer increased, the average ashing rate increased to 522.6 nm/min, and the difference was dropped to 7.3%.

However, since the peeling process involves the decomposition or cracking reaction of the resist by hydrogen radicals, separated matters produced from the reaction are mainly carbon-containing materials such as polymers, depending on the composition of the resist. When the baffle plate is not provided as in the conventional techniques, those carbon-containing materials are all brought into contact with, for example, a tungsten catalyst wire as it is, and cause a carbonization reaction on the surface thereof to produce a deformed layer formed of a carbon compound such as tungsten carbide (WC), thereby deteriorating the catalyst performance. Further, since tungsten carbide (WC) is hard and brittle, once carbonization proceeds, the deformed layer can crack and be peeled off, which not only shortens the life, but the particles thereof also cause tungsten contaminations in the chamber 2.

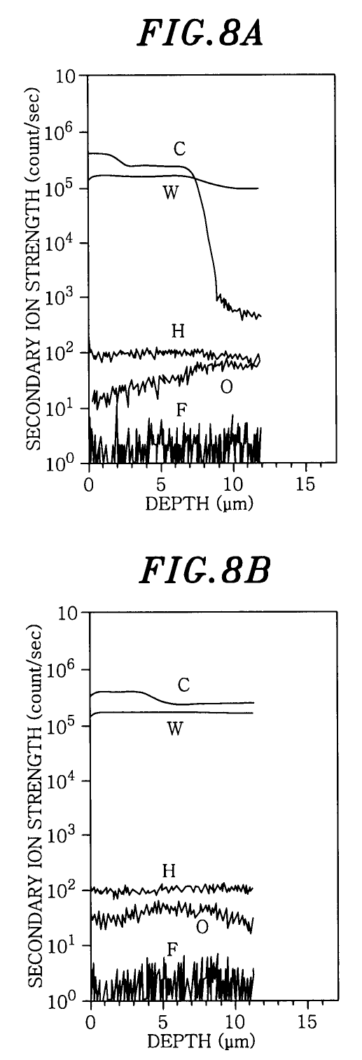

FIGS. 8A and 8B show secondary ion mass spectrometry (SIMS) results of a tungsten catalyst wire in depth direction after the resist peeling process. FIG. 8A shows the SIMS result obtained after performing the peeling process on the first lot (25 sheets of wafer) and FIG. 8B shows the SIMS result obtained after performing the peeling process on the sixth lot. As can be seen from these drawings, a carbon-rich layer is formed on the surface, and carbon (C) is gradually diffused inside as the process is repeated.

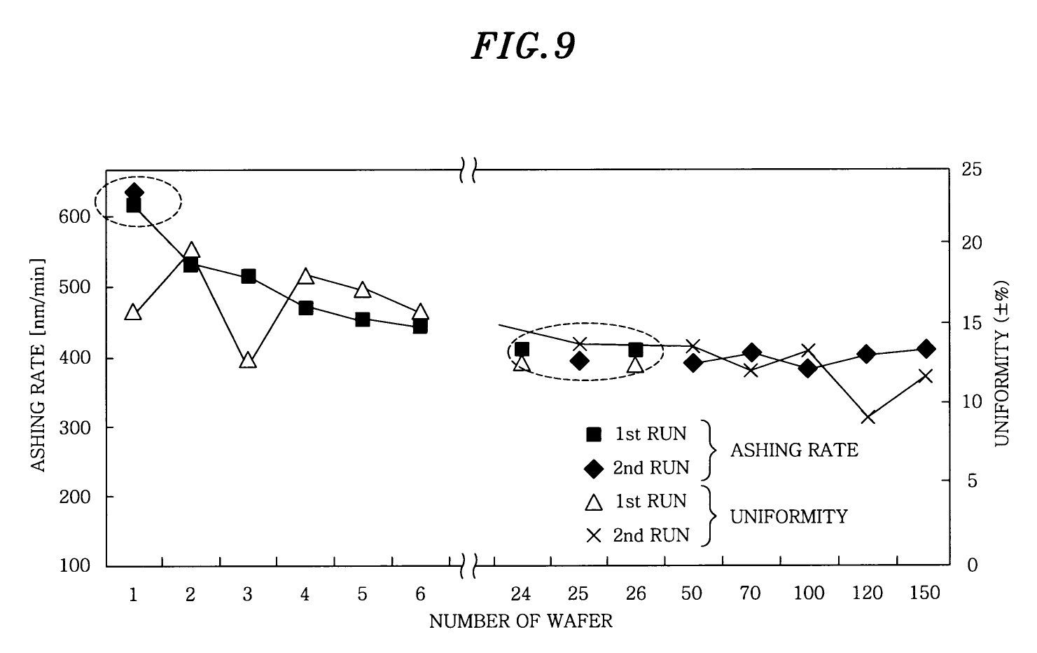

FIG. 9 shows relationships between a number of processed wafers and the ashing rate, and between the number of processed wafers and an ashing rate variation. As can be seen from this drawing, the ashing rate decreases as the number of processed wafers increases.

As shown in FIGS. 8 and 9, it is conceived that carbon diffusion proceeds from the surface as the number of wafers on which the resist peeling process has been performed increases, and the ashing rate decreases as a result of the deterioration of catalyst performance of the tungsten catalyst wire.

In the present embodiment, from the view to prevent deterioration of the catalyst wire 22, the baffle plate 26 partitions the hydrogen radical forming space 51 from the processing space 52. Accordingly, conductance is regulated so that a pressure in the processing space 52 becomes relatively lower than that in the hydrogen radical forming space 51, thereby developing a pressure difference between the spaces. As a result, even though hydrogen radicals generated by the catalyst wire 22 can easily be diffused toward the processing space 52 for processing wafer W, separated matters decomposed from the resist during a processing by the hydrogen radicals are prevented from being readily diffused into the hydrogen radical forming space 51.

In addition, with the presence of the exhausting baffle plate 27, separated matters decomposed from the resist are prevented from being readily diffused into the exhaust space 53 while conductance is regulated by the exhausting baffle plate 27, so that the pressure in the exhaust space 53 can be relatively lower than that in the processing space 52, whereby the inside of the processing space 52 can be exhausted rapidly.

More specifically, with the conductance regulation by the baffle plate 26 and the exhausting baffle plate 27, the pressure in the hydrogen radical forming space 51 can be set to 100 Torr or higher (up to about atmospheric pressure), the pressure in the processing space 52 can be set to be in a range from 1 to 10 Torr, and the pressure in the exhaust space 53 can be set to below 1 Torr to make a pressure order of the hydrogen radical forming space 51>the processing space 52>the exhaust space 53. Therefore, hydrogen radicals flow in a direction of the hydrogen radical generating space 51→the processing space 52→the exhaust space 53, but the separated matter diffusion from the processing space 52 is sufficiently suppressed.

Further, since the exhausting baffle plate 27 can suppress adhesion of the separated matters onto the walls of the exhaust space 53, the adhered matters in the chamber 2 can be sufficiently removed by dry rinsing.

Moreover, in case of the resist peeling by the hydrogen radicals, hydrogen radicals can easily go through gaps unlike the case of the plasma ashing. Therefore, since the hydrogen radicals readily enter into the rear surface of the wafer W through a micro gap formed between the wafer stage 5 and the wafer W, the backside polymer (BSP) formed on the rear surface of the wafer W can also be removed by hydrogen radicals.

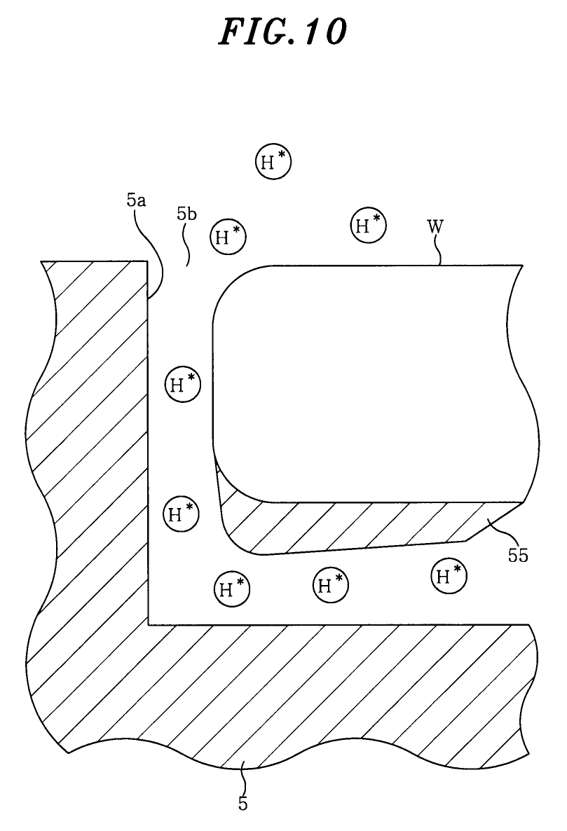

Conventionally, the development of BSP removal techniques without causing damage to the device has been required. Although the BPS removal technique by a local plasma has been suggested, it is difficult to control a plasma to have it to reach a back side of a wafer W in this technique. In this regard, in accordance with the present embodiment, when the resist peeling is performed by using hydrogen radicals instead of a plasma, as illustrated in FIG. 10, hydrogen radicals H* easily enter into the rear surface of the wafer W through a micro gap 5b formed between the recess 5a of the wafer stage 5 and the wafer W, and the BSP 55 adhered onto the rear surface of the wafer W can easily be decomposed and removed by hydrogen radicals. Accordingly, the BSP peeling, which has been regarded very difficult, can easily be carried out.

As described above, by the presence of the baffle plate 26, the catalyst wire 22 is prevented from being carbonized due to the separated matters from the resist. However, since it is not possible to completely prevent the separated matters from reaching the catalyst wire 22, although it is quite slow, carbonization may proceed on the surface of the catalyst wire 22. In this case, as illustrated in FIG. 9, the ashing rate may vary with the lapse of time in the early phase which is likely to lower the stability. However, it also can be seen in FIG. 9 that the ashing rate in this regard becomes stable after the 24th wafer.

From this standpoint, if stability is important in the resist peeling process, it is desirable to perform the carbonization reaction to form a carbon compound layer on the surface of the catalyst wire 22 until the stable ashing rate is ensured and then use it. That is, although a new catalyst wire product has a high ashing rate, the rate is liable to change. Therefore, if the stability of the resist peeling process matters, it is better to sacrifice the ashing rate to a certain extent and to apply the catalyst wire after carbonizing the surface thereof to obtain the stable ashing rate. The surface carbonization of the catalyst wire 22 can easily be achieved by taking the baffle plate 26 out of the chamber 2 and performing the above-described hydrogen radical processing to carbon-containing materials such as a resist. The baffle plate 26 is installed after carbonizing the catalyst wire to be in a stable region, the resist peeling process is performed on the wafer W.

Hereinafter, a second embodiment of the present invention will be described in detail.

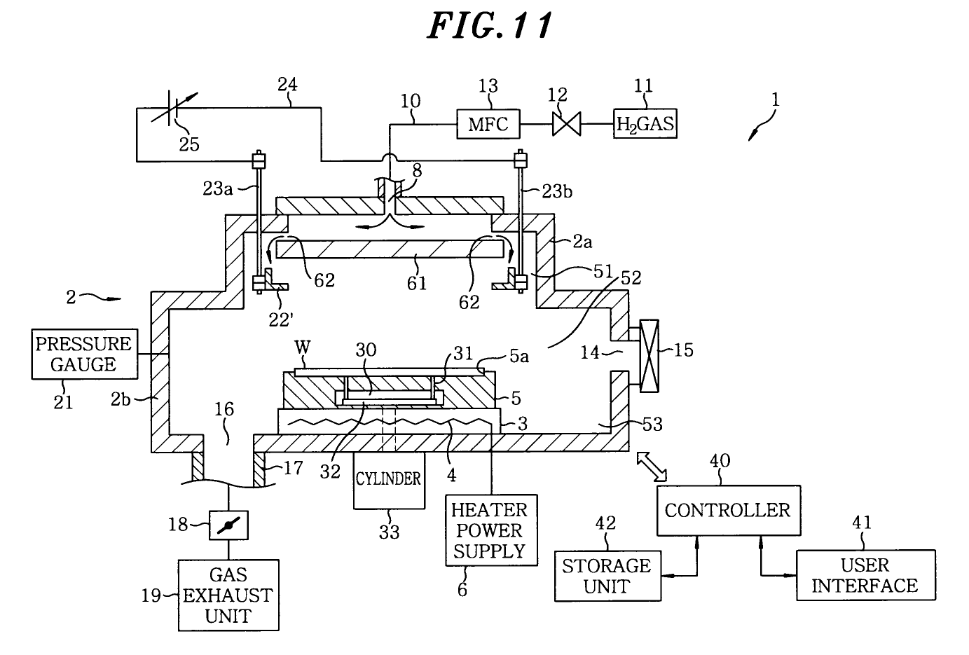

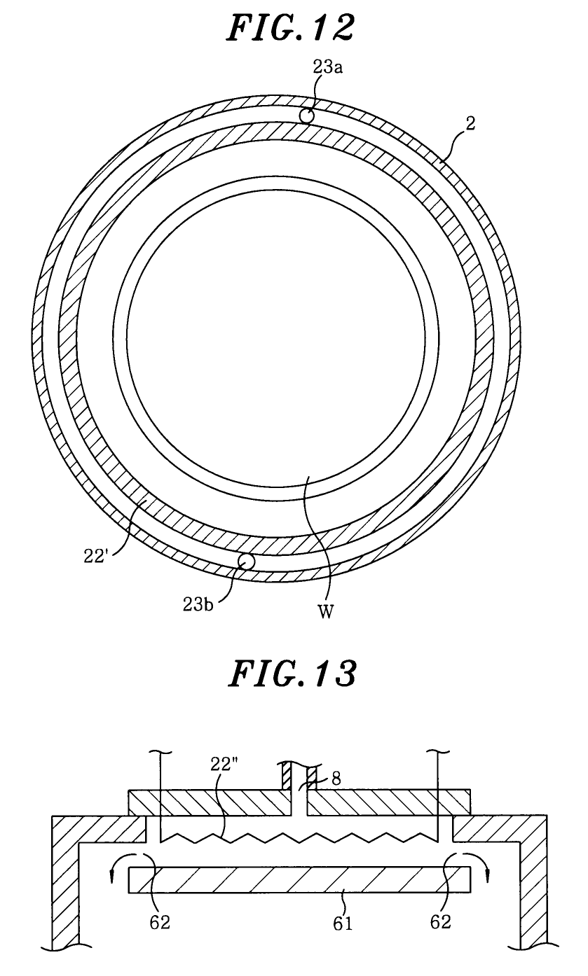

FIG. 11 is a cross-sectional view showing a substrate processing apparatus in accordance with the second embodiment of the present invention, and FIG. 12 shows an arrangement pattern of a catalyst wire in the substrate processing apparatus in FIG. 11. Like elements between FIG. 1 and FIGS. 11 to 12 are indicated by like reference numerals, and explanations thereof will be omitted. In the substrate processing apparatus 1 of the present embodiment, a disk-shaped guide member 61 is provided directly underneath a gas inlet port 8 for guiding H₂ gas introduced through the gas inlet port 8 in outer peripheral direction, and the H₂ gas is discharged in a circular shape into the chamber 2 through a discharge port 62 formed between the guide member 61 and the ceiling wall of the chamber 2. Further, as illustrated in FIG. 12, a catalyst wire 22′ of a circular shape is disposed directly underneath the discharge port 62. The arrangement pattern of the catalyst wire 22′ may be an overall circular shape formed by winding it in a coil shape, or in a form of multiple circles.

By disposing the catalyst wire 22′ in this manner, H₂ gas is brought into contact with the catalyst wire 22′ before it is diffused into the chamber 2. The H₂ gas effectively comes in contact the catalyst wire 22′, so that the hydrogen radical forming efficiency can be improved.

Conventionally, the catalyst wire was provided in a space, of which pressure was controlled at a specific level, directly above the wafer in the chamber so that the catalyst wire could meet H₂ gas after H₂ gas had been diffused into the chamber. Therefore, since the amount of H₂ gas actually reaching the catalyst wire was small, the hydrogen radicals forming efficiency was low, and this was more markedly noticeable when the inner pressure of the chamber was low. Therefore, the resist peeling rate was not always high enough.

In this regard, in accordance with the present embodiment, H₂ gas is brought into contact with the catalyst wire 22′ before it is diffused into the chamber 2 to generate hydrogen radicals with high efficiency. Accordingly, the resist peeling rate is markedly enhanced, compared with that of the conventional techniques. In this case, since hydrogen radicals are easily diffused, even if the hydrogen radicals are formed at the outer peripheral portion as such, they easily are diffused toward the center and enable the resist peeling process on the entire surface of the wafer W.

In addition, since the catalyst wire 22′ is provided in a circular shape directly underneath the gap 62, a smaller amount of separated matters generated from the resist comes in contact the catalyst wire 22′, whereby carbonization of the catalyst wire 22′ does not readily occur. Accordingly, the life of the catalyst wire is extended.

To form hydrogen radicals more efficiently, it is preferable to provide the catalyst wire 22″ in a certain space between the gas inlet port 8 and the guide member 61, as illustrated in FIG. 13.

The processing conditions used for the first embodiment can be equally applied to this embodiment. Further, the apparatus of the present embodiment can be adapted to remove backside polymer. Furthermore, in the apparatus of the embodiment, variation of the ashing rate can be regulated by changing the arrangement pattern of the catalyst wire. Additionally, the baffle plate 26 and/or the exhausting baffle plate 27 used for the first embodiment can also be applied for the apparatus of the present embodiment.

Moreover, the present invention is not limited to the embodiments described above, but may have various modifications. For instance, in the above embodiments, the present invention is applied to the resist peeling process, but the present invention is not limited thereto. In addition, in the above embodiments, although the semiconductor wafer is used as the substrate to be processed, the present invention is not limited thereto but may use other substrates as well.

While the invention has been shown and described with respect to the preferred embodiments, it will be understood by those skilled in the art that various changes and modification may be made without departing from the spirit and scope of the invention as defined in the following claims.

What is claimed is:

1. A substrate processing apparatus, comprising:
a processing vessel for accommodating a substrate therein;
a mounting table for mounting the substrate thereon in the processing vessel;
a gas inlet unit provided in the processing vessel;
a gas supply mechanism for supplying a hydrogen-containing gas into the processing vessel through the gas inlet unit;
a gas discharge port provided at the processing vessel;
a gas exhaust mechanism for exhausting an inside of the processing vessel through the gas discharge port;
a catalyst provided in the processing vessel; and
a heating unit for heating the catalyst,
wherein hydrogen radicals are formed in the processing vessel by a catalytic cracking reaction between the hydrogen-containing gas and the catalyst of high temperature, and the substrate is processed by the formed hydrogen radicals, and
the apparatus further comprises a baffle plate partitioning a space where the catalyst is present from a processing space for processing the substrate by using the hydrogen radicals.

2. The apparatus of claim 1, further comprising:
an exhausting baffle plate partitioning the space for processing the substrate by the hydrogen radicals from a gas exhaust space including the gas discharge port.

3. The apparatus of claim 1, wherein the process generates a carbon-containing material.

4. The apparatus of claim 3, wherein the baffle plate has holes, each hole having a diameter allowing the hydrogen radicals to pass therethrough but suppressing the carbon-containing material from passing therethrough.

5. The apparatus of claim 3, wherein the catalyst has a carbon compound layer pre-coated on a surface thereof.

6. The apparatus of claim 5, wherein the carbon compound layer is formed on the surface of the catalyst by performing a hydrogen radical process on the carbon-containing matter within the processing vessel.

7. The apparatus of claim 1, wherein the gas inlet unit has a shower head facing the mounting table for discharging a hydrogen-containing gas in a shower shape toward an entire surface of a substrate as the target to be mounted, and the catalyst is provided directly underneath the shower head.

8. A substrate processing apparatus, comprising:
a processing vessel for accommodating a substrate therein;
a mounting table for mounting the substrate thereon in the processing vessel;
a gas inlet unit provided in the processing vessel;
a gas supply mechanism for supplying a hydrogen-containing gas into the processing vessel through the gas inlet unit;
a gas discharge port provided at the processing vessel;
a gas exhaust mechanism for exhausting an inside of the processing vessel through the gas discharge port; a catalyst provided in the processing vessel; and
a heating unit for heating the catalyst,
wherein hydrogen radicals are formed in the processing vessel by a catalytic cracking reaction between the hydrogen-containing gas and the catalyst of high temperature, and a process is performed onto the substrate by the formed hydrogen radicals, and
the catalyst is provided in a manner that the hydrogen-containing gas introduced from the gas inlet unit is brought into contact with the catalyst before the hydrogen-containing gas is diffused into the processing vessel.

9. The apparatus of claim 8, wherein the gas inlet unit includes an inlet port for introducing a hydrogen-containing gas into the processing vessel, a guide member for guiding the hydrogen-containing gas introduced from the inlet port toward an outer periphery of an upper portion of the processing vessel, and a discharge port for discharging the hydrogen-containing gas guided by the guide member toward the outer periphery of the processing vessel in a circular shape, the catalyst being provided directly underneath the discharge port.

10. The apparatus of claim 8, wherein the gas inlet unit includes an inlet port for introducing a hydrogen-containing gas into the processing vessel, a guide member for guiding the hydrogen-containing gas introduced from the inlet port toward an outer periphery of an upper portion of the processing vessel, and a discharge port for discharging the hydrogen-containing gas guided by the guide member toward the outer periphery of the processing vessel in a circular shape, the catalyst being provided in a space between the inlet port and the guide member.

11. The apparatus of claim 1, wherein the apparatus peels off a resist formed on the substrate.

12. The apparatus of claim 8, wherein the apparatus peels off a resist formed on the substrate.

13. The apparatus of claim 1, wherein the apparatus removes a backside polymer adhered to a rear surface of the substrate.

14. The apparatus of claim 8, wherein the apparatus removes a backside polymer adhered to a rear surface of the substrate.

15. The apparatus of claim 1, wherein arrangement pattern of the catalyst is adjusted to regulate a processing rate.

16. The apparatus of claim 8, wherein arrangement pattern of the catalyst is adjusted to regulate a processing rate.

17. The apparatus of claim 1, wherein the catalyst has a wire shape.

18. The apparatus of claim 8, wherein the catalyst has a wire shape.

19. The apparatus of claim 1, wherein the catalyst is formed of tungsten.

20. The apparatus of claim 8, wherein the catalyst is formed of tungsten.
